(19) United States
(12) Patent Application Publication
(10) Pub. No.: US 2002/0042914 A1
(43) Pub. Date: Apr. 11, 2002

(54) Systems and methods for providing targeted advertisements based on current activity

(75) Inventors: Todd A. Walker, Bixby, OK (US); Michael D. Ellis, Boulder, CO (US); Stephen C. Lopp, Bixby, OK (US); William L. Thomas, Bixby, OK (US)

Correspondence Address: FISH & NEAVE, 1251 AVENUE OF THE AMERICAS, 50TH FLOOR, NEW YORK, NY, 10020-1105, US

(73) Assignee: United Video Properties, Inc.

(21) Appl. No.: 09/974,450

(22) Filed: Oct. 9, 2001

Related U.S. Application Data
(60) Provisional application No. 60/239,356, filed on Oct. 11, 2000.

(51) Int. Cl. H04N 7/025; H04N 7/10

(52) U.S. Cl. 725/36; 725/32

(57) ABSTRACT

An interactive television application is provided in which advertisements may be targeted based on current media. Targeted advertisements may be displayed in displays such as program guide information screens and video overlays. Advertisements are targeted and selected for display or excluded from display based on identifying which advertisements are associated with a current media or recently watched media. Media groupings are provided to associate media with groups of advertisements. Selection of advertisements for each media grouping can be based on programs, channels, network affiliation, sponsorship, genre or other suitable criteria.

### CROSS REFERENCE TO RELATED APPLICATION

This application claims the benefit of U.S. Provisional Patent Application No. 60/239,356 filed Oct. 11, 2000, which is hereby incorporated by reference herein in its entirety.

### BACKGROUND OF THE INVENTION

This invention relates to interactive television applications and, more particularly, to interactive television applications that provide targeted advertisements.

In conventional interactive television application systems, advertisements have been presented to users in graphical displays. Such known systems have been deficient in sufficiently matching or identifying advertisements that are relevant to a user's current interests or identifying advertisements that suitably match a user's current interests.

Targeting has been used in some known systems to target the preferences of users. However, such systems have been deficient in that they typically target advertisements to the personal likes or dislikes of a single user even though there may be a group of users who are watching television together. Moreover, such systems have been deficient in that they typically miss impulse targeting opportunities because such systems discern targeting opportunities based on user preferences that have been identified by monitoring user activity over time. Another deficiency may be that in such systems advertisements are targeted to the preferences of a user who is currently logged into the system even though that user may be watching television with other users who have different interests.

In addition, some known systems are deficient in having a sufficient link between programs and/or channels, and advertisements that are related to the programs or channels to catch marketing opportunities that arise when a particular one of those programs or channels is displayed.

### SUMMARY OF THE INVENTION

In accordance with the principles of the present invention, advertisements may be selected to be displayed in graphical displays based on currently displayed media or most recently displayed media. For example, advertisements may be displayed based on the current or most recent program or channel accessed by a user.

An interactive television application system, for example, an interactive television program guide system, may identify advertisements or groups of advertisements that are associated with or related to a current media or most recent media (e.g., a television program). Advertisements or groups of advertisements may also be associated with or related to a channel for the current or most recent media. Thus, using these associations, advertisements may be displayed to target channels, programs, or other programming attributes.

Such targeted advertisements may be displayed in any suitable format in display regions or display screens of an interactive television application. Examples of suitable formats include guide screens, listing screens, picture-in-guide displays, flip or browse overlays, reminder overlays, menu display screens, navigation display screens, information display regions, information display screens, etc. Examples of displays may extend to almost any graphical interface that an interactive television application may display to a user.

If desired, an interactive television application may select advertisements for display based on a previously tuned channel or program (e.g., the most recently viewed channel or program). The interactive television application may organize channels or programs into various groups, which are in turn associated with advertisements and used in targeting advertisements.

The Detailed Description section below may include additional summary information that may supplement this Summary section.

### BRIEF DESCRIPTION OF DRAWINGS

The principles and advantages of the invention will be apparent upon consideration of the following detailed description, taken in conjunction with the accompanying drawings, in which like reference characters refer to like parts throughout, and in which:

FIG. 1 is a schematic block diagram of an illustrative television system application in accordance with one embodiment of the present invention.

FIG. 2 is an illustrative flow chart of steps involved in targeting advertisements based on current user activity in accordance with one embodiment of the present invention.

FIG. 3 is an illustrative flow chart for displaying a flip display region with targeted advertisements in accordance with one embodiment of the present invention.

FIG. 4A is an illustrative flow chart for targeting advertisements in a flip feature in accordance with the present invention.

FIG. 4B is an illustrative flow chart for targeting advertisements in substantially full-screen features of an interactive television application in accordance with the present invention.

FIG. 5A is an illustrative diagram of an illustrative flip overlay having a targeted advertisement in accordance with the present invention.

FIG. 5B is an illustrative diagram of an illustrative browse overlay having a targeted advertisement in accordance with the present invention.

FIG. 6 is an illustrative diagram of one type of full-screen display in an interactive television application in accordance with the present invention.

FIG. 7A is an illustrative diagram showing an illustrative display region of an interactive television application that is a partial screen display that includes a targeted advertisement in accordance with the present invention.

FIG. 7B is an illustrative diagram of a substantially full-screen display screen in accordance with the present invention.

FIG. 8 is an illustrative diagram of how various channels may be associated with groups of advertisements in accordance with one embodiment of the present invention.

FIG. 9A is an illustrative flow chart of how advertisement map records may be used to display targeted advertisements in accordance with one embodiment of the present invention.

FIG. 9B is an illustrative flow chart of how advertisement map records may be used to display targeted advertisements in accordance with one embodiment of the present invention.

FIG. 10A is an illustrative diagram of records that may be used to implement targeted advertisements in accordance with one embodiment of the present invention.

FIG. 10B is an illustrative diagram of an advertisement map record that may be used to implement targeted advertisements in accordance with one embodiment of the present invention.

### DETAILED DESCRIPTION

In accordance with the principles of the present invention, users are provided with programs from different media (e.g., television programs, pay-per-view (PPV) programs, near-video-on-demand (NVOD) programs, video-on-demand (VOD) programs, music, promotional materials, and other types of media). Programs may be delivered to a display device of a user via distribution systems such as broadcast systems, cablecast systems, satellite systems, or any other suitable systems which can be either wired, wireless, or a combination thereof. Distribution systems may include computer networks, which may be private or public (e.g., the Internet), or a combination thereof. Any suitable combination of television distribution systems and computer networks can be used, for example, media may be provided via the Internet and a cablecast system with computer networks that receive and transmit data with cable modems.

Interactive television applications (e.g., interactive television guidance applications) may be used with a wide range of media (e.g., VOD programs, broadcast television programs, media available from an Internet site, DVR recorded programs, etc.). Illustrative interactive television applications are described, for example, in Knee et al. U.S. Pat. No. 5,589,892, filed Jun. 7, 1995, and Knudson et al. U.S. patent application Ser. No. 09/357,941, filed Jul. 16, 1999, which are hereby incorporated by reference herein in their entireties. Interactive television applications may be implemented to display graphical displays on computer monitors, televisions, or other suitable hardware that display programs or other media to users.

Interactive television applications may be based on a number of different hardware platforms. Suitable hardware that may be used in implementing interactive television applications includes hardware such as satellite receivers, personal computer televisions (PC/TVS), personal computers (e.g., with television tuner cards), cable set-top boxes, televisions, videocassette recorders (VCRs), or any other suitable hardware. Interactive television application data may be provided on a television channel sideband, using an out-of-band digital data stream, or by any other suitable data transmission technique.

In one approach, interactive television applications may be implemented on cable set-top boxes and on interactive television application servers using a client-server architecture. Client-server interactive television application systems are described, for example, in Ellis et al. U.S. patent application Ser. No. 09/374,043, filed Aug. 13, 1999, which is hereby incorporated by reference herein in its entirety. A server may be located at the cable system headend or other suitable location. The interactive television application may be an on-line interactive television application, which may be implemented using an Internet Web server. On-line interactive television application systems are described, for example, in Boyer et al. U.S. patent application Ser. No. 08/938,028, filed Sep. 18, 1997, which is hereby incorporated by reference herein in its entirety.

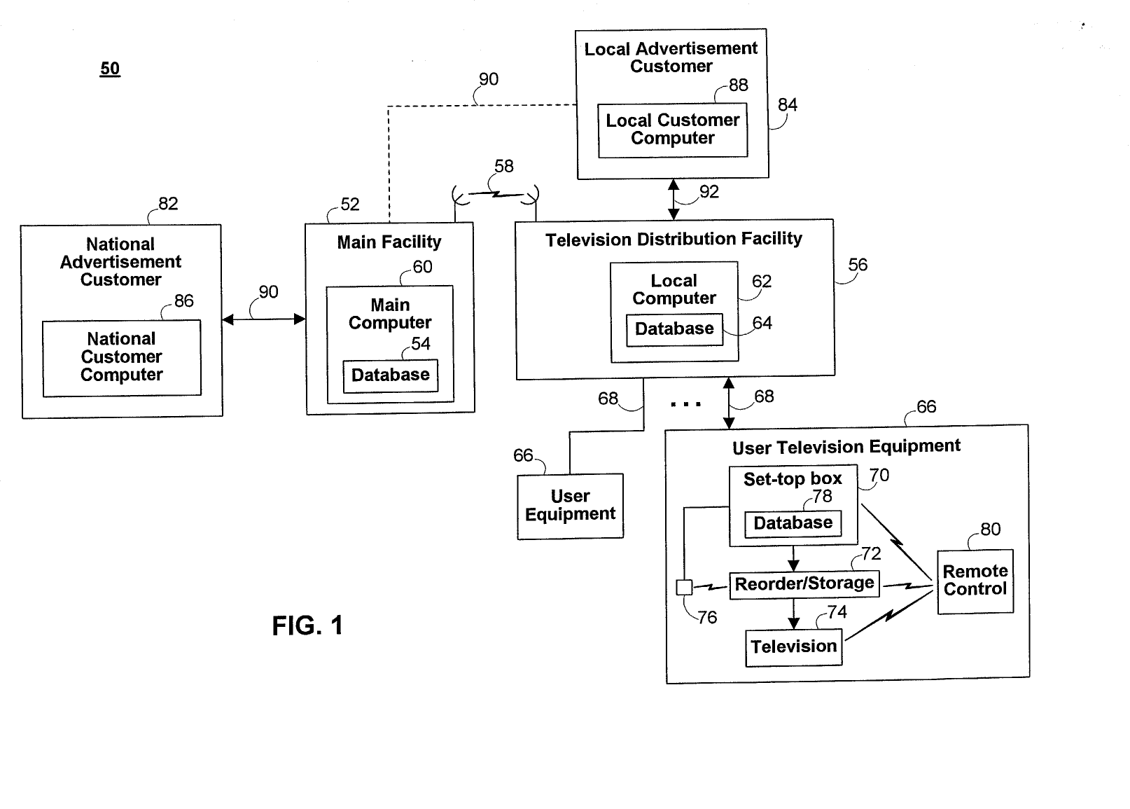

An illustrative interactive television application system 50 in accordance with the present invention is shown in FIG. 1. Main facility 52 may contain main computer 60 that contains a database 54 for storing interactive television application information such as television program guide listings data, pay-per-view ordering information, television program promotional information, etc. Database 54 may also be used for storing advertising information. Information from database 54 may be transmitted to television distribution facility 56 via communications link 58. Link 58 may be a satellite link, a telephone network link, an Internet link, a cable or fiber optic link, a microwave link, a combination of such links, or any other suitable communications path.

Television distribution facility 56 is a facility for distributing television signals to users, such as a cable system headed, a broadcast distribution facility, or a satellite television distribution facility.

Information transmitted by main facility 52 to television distribution facility 56 may include program guide information, which may include television program listings data such as program times, channels, titles, descriptions, etc. The transmitted information may also include pay program data such as pricing information for individual programs and subscription channels, time windows for ordering programs and channels, telephone numbers for placing orders that cannot be impulse ordered, etc. The advertising information transmitted by main facility 52 to television distribution facility 56 may include text, graphics, video advertisements, and scheduling information for various products and services. If desired, some of the information for the interactive television application and advertisements may be provided using data sources at facilities other than main facility 52. For example, data related to pay program order processing (e.g., billing data and the like) may be generated by an order processing and billing system that is separate from main facility 52 and separate from television distribution facility 56. Similarly, advertising information may be generated by an advertising facility that is separate from main facility 52 and television distribution facility 56.

Regardless of its source, advertising information may be maintained on a local computer 62 within television distribution facility 56 if desired. Local computer 62 may be capable of handling text, graphics, and video. Local computer 62 may, for example, be a server.

Television distribution facility 56 distributes information for the interactive television application and advertisements to the user equipment such as user television equipment 66 of multiple users via communications paths 68. User equipment may have a set-top box architecture or a personal computer based architecture. User equipment may have a communication connection with a computer network such as the Internet that may be part of paths 68 or may be separate from paths 68. User television equipment 66 may be any suitable equipment or device for providing television to the user that contains sufficient processing capabilities to implement an interactive television application, such as an interactive television program guide. Paths 68 may be cable links, fiber optic links, satellite links, broadcast links, or other suitable link or combination of such links. Any suitable communications scheme may be used to transmit data over paths 68, including in-band transmissions, out-of-band transmissions, digital transmissions, analog transmissions, cable transmissions, satellite transmissions, cable modem transmissions, over-the-air transmissions, multichannel multipoint distribution services (MMDS) transmissions, etc.

If desired, interactive television application data may be distributed over an out-of-band channel on paths 68 or over an in-band path such as the vertical blanking interval (VBI). Advertising information may be distributed using any of a number of suitable techniques. For example, text and graphics advertisements may be distributed over an out-of-band channel using an out-of-band modulator. Video advertisements may also be distributed in this way, although large quantities of video information may be more efficiently distributed using one or more digital channels or data streams on path 68. Such digital channels or data streams may also be used for distributing text and graphics.

Each user has a receiver, which is typically a set-top box such as set-top box 70, but which may be other suitable television equipment such as an advanced television receiver into which circuitry similar to set-top-box circuitry has been integrated, a personal computer television (PC/TV), or a personal computer (e.g., with a television tuner cord). Interactive television application data may be distributed to set-top boxes 70 periodically, on-demand, continuously, or in a combination thereof. Television distribution facility 56 may also poll set-top boxes 70 periodically for certain information (e.g., pay program account information or information regarding programs that have been purchased and viewed using locally-generated authorization techniques). Main facility 52 preferably contains a processor to handle information distribution tasks. For example, main computer 60 within main facility 52 may handle such tasks. Each set-top box 70 preferably contains a processor to handle tasks associated with implementing an interactive television application, examples of which include home shopping applications, web browser applications, home banking applications, video-on-demand applications, chat applications, email applications, etc. For clarity, the present invention will be described primarily in the context of interactive television program guides, but the invention also applies to other interactive television applications. Television distribution facility 56 may contain a processor for handling tasks associated with the distribution of information for interactive television applications and advertisements. For example, television distribution facility 56 may contain local computer 62 for handling such tasks.

Each set-top box 70 is typically connected to an optional recorder/storage device 72 so that selected television programs or other media may be recorded. Each recorder/storage device 72 is connected to a television 74 or other viewing device. To record a program, set-top box 70 tunes to a particular channel and sends control signals to recorder/storage device 72 (e.g., using infrared transmitter 76) that direct recorder/storage device 72 to start and stop recording at the appropriate times. If desired, any suitable recording/storage device may be used, including digital video recorders, a video cassette recorder (VCR), a digital video disk (DVD) player with recording capabilities, hard disk, etc. Recorder/storage device 72 may also be a personal video recorder (“PVR”) such as TiVo and Replay. In PVRs, the device may determine when to record or store programs based on information from the user, from the set-top box, or based on parameters that the PVR has identified.

During use of the interactive television application implemented on set-top box 48, television program listings may be displayed on television 52 or other suitable monitor. Each set-top box 70, recorder/storage device 72, and television 74 may be controlled by one or more remote controls 80 or any other suitable user input interface such as a wireless keyboard, mouse, trackball, dedicated set of keys, touch screen display remote, etc.

Communications paths 68 preferably have sufficient bandwidth to allow television distribution facility 56 to distribute scheduled television programming, pay programming, advertising and other promotional videos, and other video information to set-top boxes 70 in addition to data for non-video interactive television applications and advertisements. Multiple television and audio channels (analog, digital, or both analog and digital) may be provided to set-top boxes 70 via communications paths 68. If desired, program listings and advertising information may be distributed by one or more distribution facilities that are similar to but separate from television distribution facility 56 using communications paths that are separate from communications paths 68.

Certain functions such as pay program purchasing may require set-top boxes 70 to transmit data to television distribution facility 56 over communications paths 68. If desired, such data may be transmitted over telephone lines or other separate communications paths. If functions such as these are provided using facilities separate from television distribution facility 56, some of the communications involving set-top boxes 70 may be made directly with the separate facilities.

Users may interactively order additional information, products, or services. Such orders may be satisfied by fulfillment facilities (not shown). If desired, orders may be transmitted directly to fulfillment facilities via links which may be telephone links, the Internet, or other suitable communications links. Orders may also be transmitted to television distribution facility 56 via links 68, where the billing system of the television distribution facility may be used. After the television distribution facility 56 has processed the user's order, television distribution facility 56 may transmit the order to a fulfillment facility.

A number of suitable techniques may be used to distribute videos related to advertising. For example, if each path 68 includes a number of traditional analog television channels, one or more of these channels may be used to support a number of digital channels (or data streams). The bandwidth of each analog channel that is used to support digital channels may support ten or more of such digital channels. If desired, videos may be provided from local computer 62 in a continuously looped arrangement on these digital channels. Information provided to set-top box 70 may then be used to determine which digital channels to tune to when it is time to display a desired video. If desired, videos may be provided on demand. With this approach, set-top box 70 and local computer 62 may negotiate to determine a channel on which to provide the desired video. Videos that originate from main facility 52 or a separate facility are preferably distributed to user television equipment 66 using these or other suitable techniques.

Graphics information for advertisements may be downloaded periodically (e.g., once per day) to set-top boxes 70 and stored locally. For example, set-top box 70 may contain database 78 for storing graphics information. The graphics information may be accessed locally when needed by the interactive television application implemented on set-top box 70. If desired, graphics information may be provided in a continuously-looped arrangement on one or more digital channels on paths 68. With such a continuously-looped arrangement, a map indicating the location of the latest graphics information may be downloaded periodically to set-top boxes 70 (e.g., once per day). This allows the content on the digital channels to be updated. The interactive television application running on set-top boxes 70 may use the map to locate desired graphics information on the digital channels. Another approach involves using a server such as local computer 62 to provide the graphics information after a set-top box 70 and that server have negotiated to set up a download operation. A bitmap or other suitable set of graphics information may then be downloaded from the server to the set-top box. If desired, the server may download instructions informing the set-top box where the desired graphics information can be located on a particular digital channel. The graphics information can be updated periodically if the server that is responsible for downloading the instructions for informing the set-top box of the location of the graphics information is also updated periodically.

Text information for advertisements may be provided to set-top boxes 70 using the same paths that are used for distributing interactive television application data. For example, advertising data from database 54 may be provided to set-top boxes 70 using link 58, television distribution facility 56, and paths 68. The text information may be stored locally in set-top boxes 70 and updated using periodic transfer techniques (e.g., once per day), on-demand transfer techniques, continuous transfer techniques, or combinations thereof.

Text information, graphics information, and videos for advertisements may also be distributed using a combination of these techniques or any other suitable technique. Interactive television application data and/or advertisement data (such as videos) may also be stored using recorder/storage device 72 for later retrieval.

If desired, an interactive television application may be implemented using a data-relay architecture. In such an architecture, television distribution facility 56 may serve as a data relay site and user television equipment 66 may be a data destination site. For example, television distribution facility 56 may continuously or periodically distribute information as the information is received. In a data-relay architecture, an interactive television application implemented on user television equipment 66 may use a database (e.g., database 78) for storing interactive television application and advertising information at user television equipment 66. Interactive television application information may include program listings and program attributes. Advertising information may include interactive advertisement and scheduling information. Television distribution facility 56 may also poll set-top boxes 70 periodically for certain information (e.g., pay program account information or information regarding programs that have been purchased and viewed using locally-generated authorization techniques).

The features of the present invention may be implemented in a client-server arrangement or in a combination client-server and data-relay arrangement.

For clarity, the present invention is sometimes described primarily in the context of interactive television applications that are implemented on user television equipment 66 rather than in the context of interactive television applications that are implemented partially on local computer 62 and partially on user television equipment 66 or a more fully server-based architecture.

Interactive advertisement orders may be placed by customers such as national advertisement customer 82 and local advertisement customer 84. Orders for advertisements may be placed using computer systems at main facility 52 and at locations external to main facility 52 such as at national advertisement customer 82 or at local advertisement customer 84. Computer systems at advertisement customer locations such as national customer computer 86 and local customer computer 88 may store interactive advertisements, may include executable code for ordering the scheduling and display of interactive advertisements, and may include executable programming in combination with communication equipment for transmitting orders, advertising information, or advertisements to main facility 52 via path 90. If desired, local customer 84 may also use path 92 to transmit orders, advertising information, or advertisements directly to television distribution facility 56. Path 90 may provide Internet communications paths between main facility 52 and advertisement customers 82 and 84. Path 92 may be used to support Internet communications between television distribution facility 56 and local advertisement customer 84. If desired, paths 90 and 92 may also be any other suitable communications path capable of handling such advertising related data.

After the initial reception of advertisements and advertisement-related information from advertisement customers 82 or 84, main facility 54 may transmit advertisements and such related information to television distribution facility 56 for further distribution. Advertisements and related information may then be stored at database 64 and may be distributed continuously, periodically, or on-demand to user television equipment 66. A combination of continuous, periodic, or on-demand distribution techniques may also be used. Database 78 at user television equipment 66 may also store advertisements and advertisement-related information for presenting advertisements to users. Main facility 52, television distribution facility 56, or user television equipment 66 may be used individually or in combination for scheduling the presentation of advertisements. Interactive advertisements are typically digital interactive advertisements. For convenience, interactive advertisements are sometimes simply referred to as advertisements.

User television equipment 66 may include sufficient hardware and software capabilities to monitor or determine user interactions with user television equipment 66 such as to determine the current channel and/or program that the user is watching or was most recently watching.

Television distribution facility 56 may include sufficient hardware and software capabilities to provide media on-demand services to user equipment such as user television equipment 66. For example local computer 62 may be used in providing video-on-demand services to user equipment.

Advertisers and system providers may use the advertisements on the system to target advertising based on determining the current media (e.g., attributes of the current channel or program) that a user is watching or based on attributes of the current media (e.g., attributes of the current channel or the current program) that the user is watching. Targeting may also be based on the most recent media (e.g., the most recent channel or program) that the user watched or based on the attributes of the most recent media (e.g., attributes of the most recent channel or program) that the user watched. For clarity and brevity, the targeting features are primarily discussed in the context of targeting based on programs or channels, rather than in the context of targeting based on media.

These targeted advertisements may be passive or interactive, and may include text, graphics, video, any other suitable content, or combinations thereof. These targeted advertisements may be displayed in any suitable format. For example, advertisements may be selected to be displayed in a flip overlay based on the current channel that is being viewed. Other formats suitable for display may include browse displays, picture-in-guide displays, or any other display screen or region that an interactive television application may display to a user when a user accesses or enters the interactive television application. For clarity and brevity, such targeted advertising is sometimes discussed primarily in the context of interactive television program guidance applications. Other interactive television applications or guidance applications may also be used.

Targeted advertisements may be presented differently based on the hardware platform used to implement the interactive television application. For example, if the interactive television application is implemented using a client-server architecture, the server may store groups of advertisements that are associated with different channels or groups of channels. The interactive television application may send requests for advertisements to the server. The server may then send the advertisements to the user equipment in a television sideband signal, or in any other suitable type of signal or data.

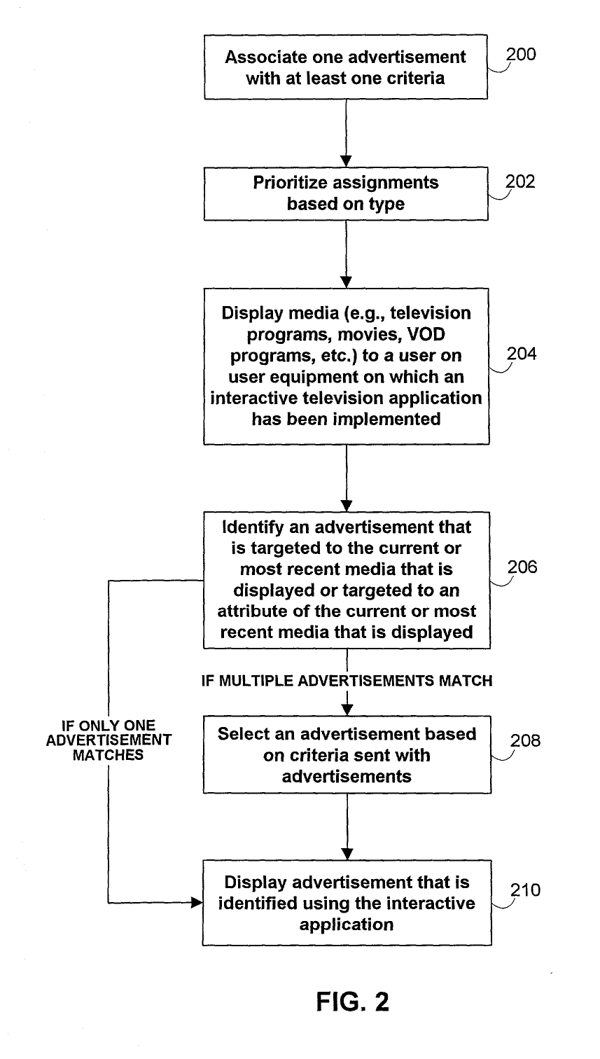

FIG. 2 shows illustrative steps that may be implemented in a system such as system 50 of FIG. 1 to implement targeted advertising based on current or most recent user activity. At step 200, one advertisement may be associated with at least one targeting criterion (e.g., channel, network, program, or any other suitable attribute). At step 202, advertisements may be selected for different types of displays (e.g., flip displays, full screen panel displays, etc.) and time periods. Advertisements may be selected based on whether the advertisements are targeted to programs, channels, networks, genres, or any other suitable criteria. Targeted advertisements may be prioritized based on the programming attribute to which the advertisement is targeted. For example, advertisements targeted to programs may have a higher priority than advertisements targeted to channels.

At step 204, media (e.g., a television program or other media on a channel) may be displayed on user equipment on which an interactive television application has been implemented. At step 206, the interactive television application may identify advertisements of the desired display type (e.g., banner, full screen, etc.) that are targeted to the current media or most recent media that has been accessed by the user or targeted to an attribute related to the current media or most recent media that has been accessed by the user. For example, the media may be a currently displayed program or a program that was most recently displayed. The media may be a program on a current channel or a program on a most recently tuned channel.

Advertisements may be associated with media by associating information with an advertisement that indicates a relationship or link between that advertisement and particular media or media sources (e.g., an advertisement may be associated with the name of a television program or with a channel identifier). Advertisements may be associated with groups of channels (e.g., associated with broadcast television channels). Conversely, channels may have information associated with them that establishes a relationship or link with particular advertisements. Channels and/or advertisements may be grouped to provide for a more efficient advertising connection between channels and advertisements.

Advertisements may be identified to be related to media based on attributes of the media. For example, advertisements may be identified based on program attributes (e.g., actors, ratings, genre, series, etc.), based on channel attributes (e.g., broadcast channel, cable channel, theme, network affiliation, etc.), and based on any other attribute that is available for the current or most recent media. Advertisements may have associated attribute information to aid in identifying advertisements that are related to the current or most recent media.

At step 208, if multiple advertisements were identified at step 206, one or more advertisements may be selected for display based on pre-determined or otherwise specified criteria sent with the advertisements ahead of time. Such criteria may include a priority scheme that prioritizes advertisements based on the last viewing of the advertisement. A non-targeted advertisement may be selected for display when advertisements that are targeted are unavailable or when suitable targeted advertisements were not identified at step 206. At step 210, the interactive television application may display an advertisement that was specified in step 208 as being related to or associated with the current media. The advertisement may be displayed to suitably match the user's current interests or to exploit an advertising opportunity that may be available in connection with the current media.

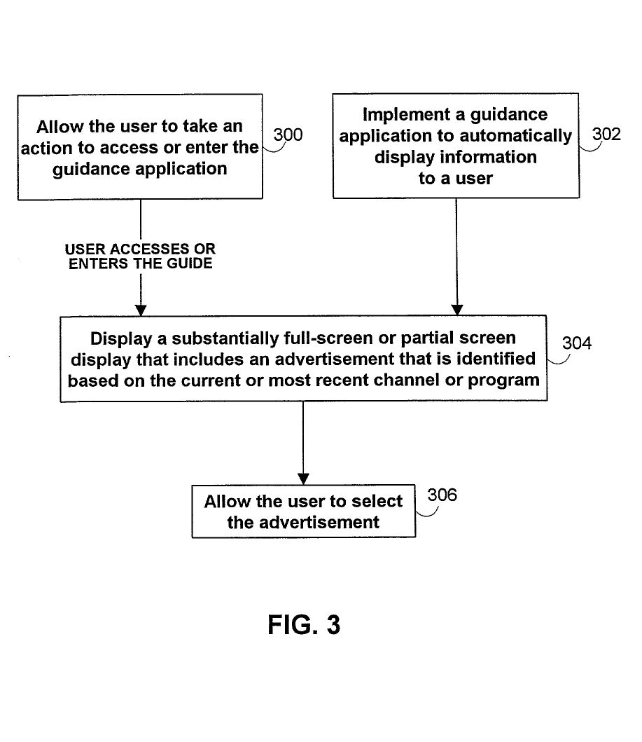

Illustrative steps that are involved in displaying such targeted advertisements and in determining when and where to display such targeted advertisements are shown in FIG. 3. At step 300, a user may be provided with an opportunity to access or enter the interactive television application. The user may be given such an opportunity through a remote control or other user interface device. A user may make selections on the remote control to communicate with the interactive television application and invoke interactive television application features. At step 304, the interactive television application may display a substantially full-screen sized or partial-screen sized display that includes an advertisement that was identified to be display based on the current or most recent channel (or program) accessed by the user. The substantially full-screen or partial screen display may be almost any display screen, overlay, or region that the interactive television application may display to a user in providing interactive television application features.

In some configurations, the interactive television application may display interactive television application display screens or regions automatically. Accordingly, at step 302, the interactive television application may automatically initiate step 304 to be performed without requiring a direct user selection. At step 306, the interactive television application may provide the user with an opportunity to select the advertisement. The advertisement may be an interactive advertisement that may be selected by a user to access additional information about the advertised product, to purchase the advertised product, or to take any other suitable action. Advertisements may be for a specific category, for example, program series, network programming, VOD programs, or the like. The selection of an advertisement may allow the user to perform related actions such as setting a reminder, recording media, purchasing programs, selecting favorites, tuning to another channel, or any other suitable action. These related actions may be performed through interactive information display screens, as described in Rudnick et al. U.S. patent application Ser. No. 09/356,268, filed Jul. 16, 1999 which is hereby incorporated by reference herein in its entirety. Selections may be made by using a user input interface device such as a remote control. Techniques for implementing such selection functionality are known to those skilled in the art.

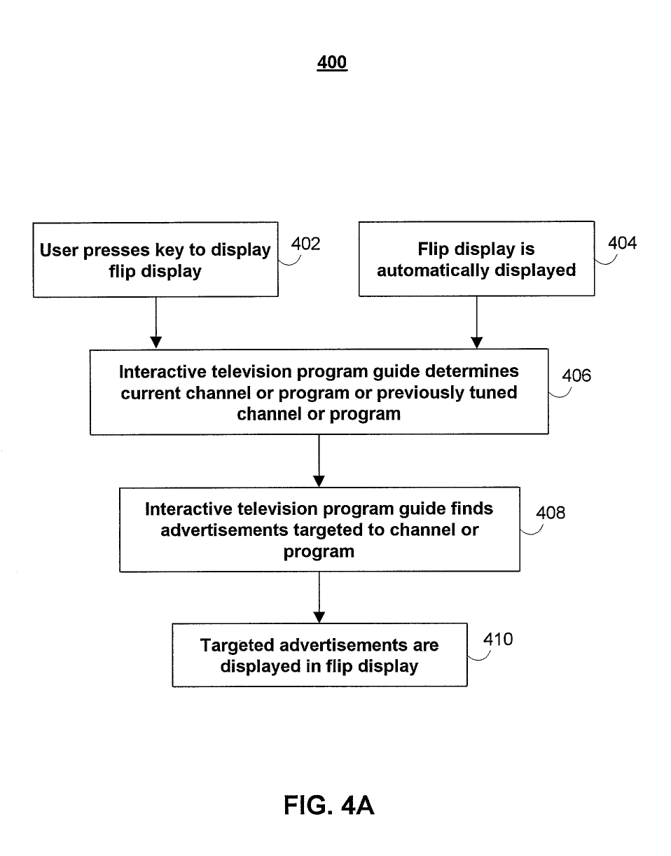

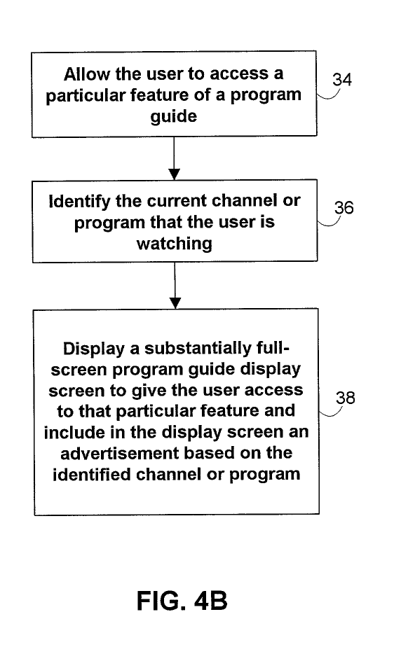

In one embodiment of the present invention, program information may be displayed by the interactive television application in a flip display (e.g., a flip overlay). Illustrative flow chart 400 of FIG. 4A illustrates a process that may be used by the interactive television application to select targeted advertisements for display in flip displays. At steps 402 and 404, the user may either press a suitable key to display a flip display or the flip display may be automatically displayed. At step 406, the interactive television application determines a current channel (or program) or determines a previously tuned channel (or program). At step 408, the interactive television application may find advertisements that are targeted to one or more attributes of a current or previous (e.g., most recent) channel or program. Step 408 may also include sub-steps of selecting among multiple advertisements based on target type and priority, and selecting a non-targeted advertisement for display if no targeted advertisement or no suitable targeted advertisement is available. At step 410, targeted advertisements are displayed by the interactive television application in a flip display.

Advertisements that are targeted to a current or most recent channel or program may be displayed by the application in a substantially full-screen display screen when a user accesses interactive television application features. Illustrative steps involved in displaying such targeted advertising is shown in FIG. 4B. At step 34, the interactive television application may provide the user with an opportunity to access a particular interactive television application feature. For example, the user may seek to use a parental control feature, a program searching feature, a reminder feature, a favorites feature, a preference profile feature, a media on-demand feature, a DVR feature, etc. At step 36, the interactive television application may identify the current channel or program that the user is watching. Other types of media may also be identified for targeting. The interactive television application may identify the current channel or program based on program guide schedule information, based on determining the channel to which the user equipment is tuned, or based on any other technique.

At step 38, the interactive television application may display a substantially full-screen program guide display screen to provide the user access to the particular program guide feature that user seeks to access. The interactive television application may display an advertisement in the display screen that is targeted to the channel or program that was identified in step 36. The advertisement that is displayed may be selected for display based on having a direct association or group association with the channel or program or may be selected for display based on containing subject matter that is related to the attributes of the current channel or program.

The distinction between using the current media versus using the most recent media involves circumstances when display screens or display regions are displayed without concurrently displaying media that was most recently accessed by the user. In such circumstances, when for example, the program guide has displayed a substantially full-screen sized display screen, the program guide may identify advertisements for display based on the most recent program or channel that was watched or accessed (i.e., watched or accessed directly before displaying the substantially full-screen display screen).

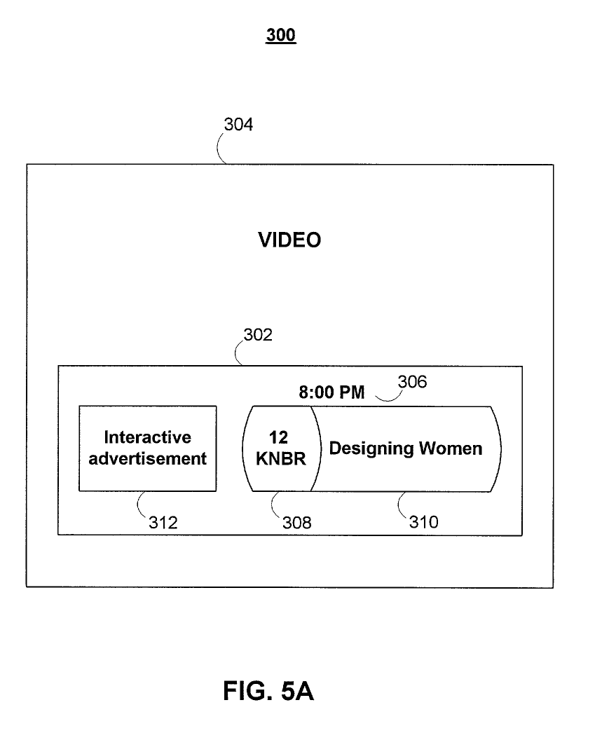

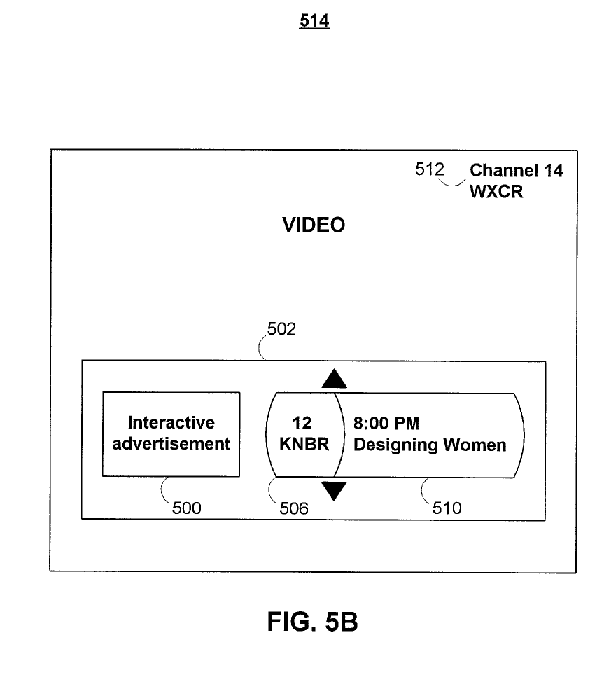

Illustrative display screen 300 of FIG. 5A includes flip display 302 that is overlaid over video 304. Video 304 may be a television program, a VOD program, an NVOD program, or any other suitable program displayable by user equipment. Flip display 302 may be provided by the interactive television program guide in response to a user selection made with a user input device. Flip display 302 may be displayed when the user presses a suitable key (e.g., a “Flip” key) on a user input device. If desired, flip display 302 may be automatically displayed by the interactive television program guide, for example, when the channel is changed and a new program/channel is selected. Flip display 302 may be displayed based on the illustrative steps of FIGS. 2-3 and 4A.

Illustrative flip display 302 of FIG. 5A may include program start time 306, channel identifier 308, and program information 310 for the program that is currently displayed to the user. Other items displayed in flip display 302 may include targeted interactive advertisement 312. Advertisement 312 may have been selected based on the current program or based on the channel showing video 304. For example, video 304 may be video of a sports channel or video of a live sports program, and advertisement 312 may be an advertisement for a sports related product. Advertisement 312 may have been selected from a group of advertisements associated with the current channel. If desired, a group of advertisements may be associated with a particular channel where the advertisements that are specifically included in that group are limited to advertisements from particular vendors.

Flip display 302 may be displayed for a fixed period of time by the interactive television program guide, or may be displayed for a selectable period of time. During the time that flip display 302 is displayed, the interactive television application may select another advertisement from a group of advertisements with which the current channel or program is associated. Subsequent advertisements may also be selected based on the current or most recent media.

In order to change the channel, the user may use suitable keys on a user input device such as channel up and channel down keys to change the channel. When the channel changes, targeted interactive advertisement 312 may change because the interactive television program guide may identify a new advertisement to display that is associated with or related to the new current channel or program.

Illustrative browse display 502 is shown in display screen 514 of FIG. 5B. Region 506 of browse display 502 may be selected by the user with highlight region 506 as shown in display screen 514 of FIG. 5B. When region 506 is highlighted, the user may change browse display 502 to show information for a different channel by pressing suitable keys on a user input device. Targeted advertisements may be selected for display in browse display 502. Advertisements may be targeted based on the currently tuned channel, as identified by channel identifier 512. If desired, advertisements may be targeted based on a previously tuned channel. Alternatively, video may be reduced in size so that browse display 502 does not obscure video.

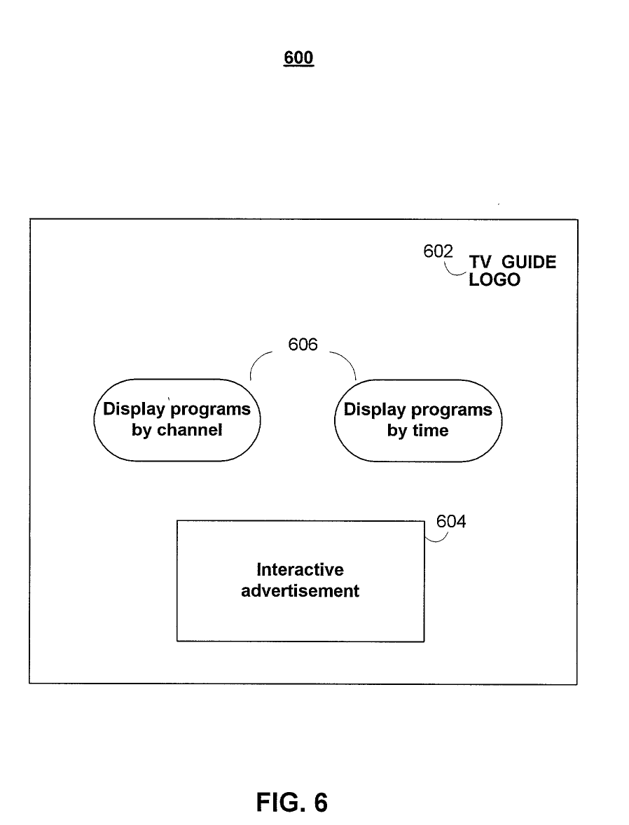

In another approach, targeted advertisements may be displayed as an overlay over display screens provided by the interactive television program guide. Illustrative display screen 600 of FIG. 6 includes logo 602, selectable interactive television program guide options 606 (e.g., a selectable button in a navigation display screen), and interactive advertisement 604. Interactive advertisement 604 may be selected from a group of advertisements associated with or related to the most recently watched channel or program.

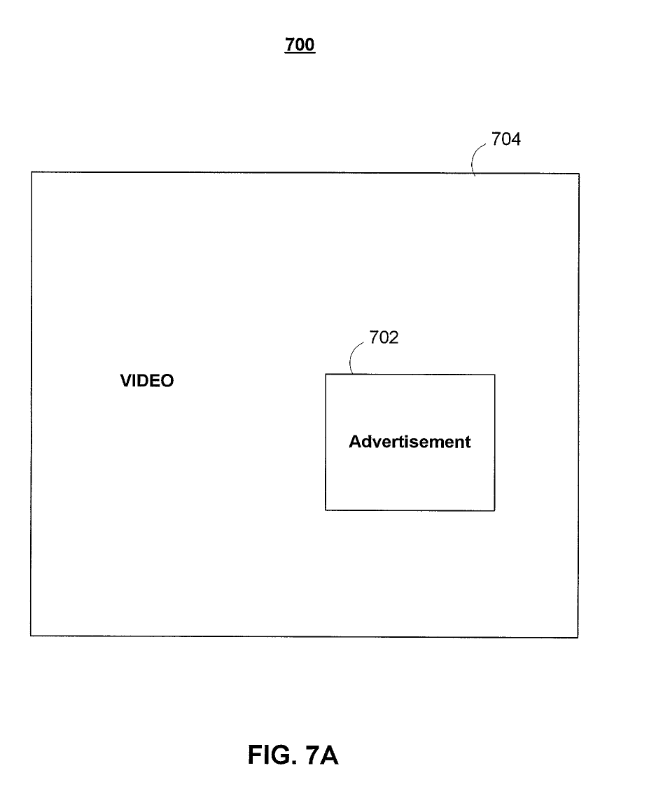

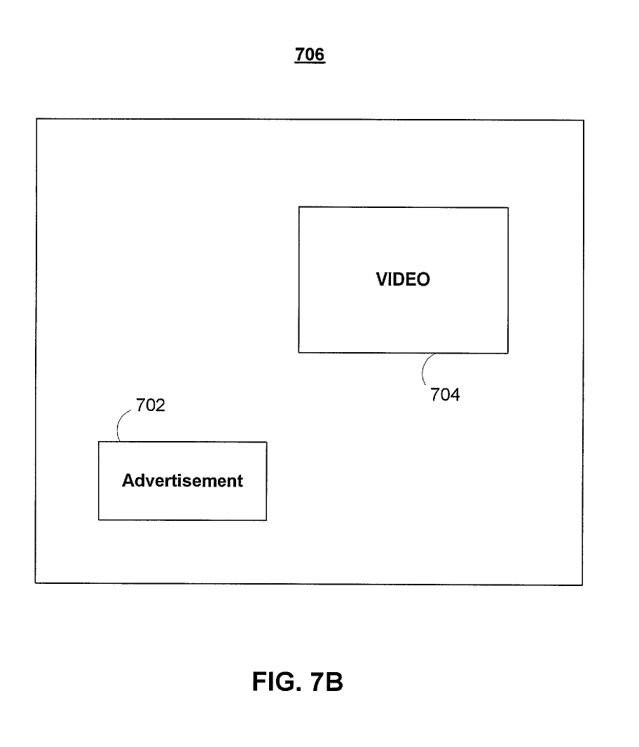

In another approach, the interactive television program guide may also display targeted ads as graphical displays in conjunction with any video of a currently displayed network, channel, or program. Display screen 700 of FIG. 7A includes targeted advertisement 702 that may be presented as a graphical overlay over video 704. Video 704 may be a video of a currently selected network, channel, or program. Alternatively, video 704 may be presented with a reduced aspect ratio as shown in display screen 706 of FIG. 7B so that targeted advertisement 702 does not obscure any part of video 704.

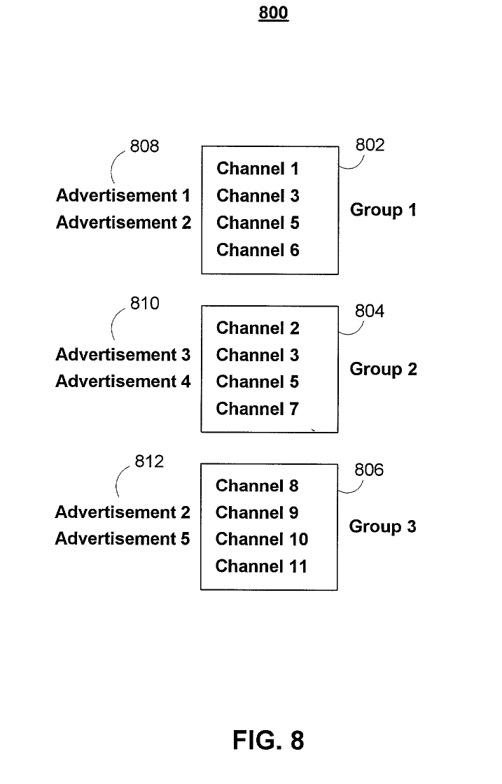

FIG. 8 shows one embodiment of how advertisements may be targeted based on current or previously tuned channels. Diagram 800 shows data structures 802, 804, and 806. Each of these data structures represents a channel grouping that is associated with a group of advertisements. As shown in FIG. 8, data structure 802 may include Channels 1, 3, 5, and 6; data structure 804 may include Channels 2, 3, 5, and 7; and data structure 806 may include Channels 8, 9, 10, and 11. Data structure 802 may be associated with group 808 of advertisements; data structure 804 may be associated with group 810 of advertisements; and data structure 806 may be associated with group 812 of advertisements. As illustrated in FIG. 8, the same advertisement, advertisement 2 may belong to two groups.

A user may tune user equipment (e.g., a set-top box) to Channel 1. An interactive television application implemented on the user equipment may provide targeted advertisements by selecting advertisements for display from group 808. Alternative data structure arrangements may include the association of more than one group of advertisements with each channel grouping. The selection of advertisements to be associated with a channel grouping may be based on shared characteristics such as network affiliation, sponsorship, genre, and other suitable characteristics.

Targeted advertisements may also be provided by the interactive television program guide through the use of negative association. For example, advertisements may be excluded from display by using the data structures illustrated in FIG. 8. Advertisements that are to be excluded from display for a specific channel or group of channels may be assembled into a group that is negatively associated with a channel or channel grouping.

It may be desirable to provide targeted advertisements through the use of records that represent advertisements, advertisement maps, channels, programs, networks, genres, and other aspects of interactive television applications. Each of these aspects may be represented by records having a specific type of structure. For example, records that represent advertisements, “advertisement records”, may be of a specific structure. Advertisement records may include a fixed number of data fields, each of which may be assigned different values or may include any number of data fields. Every unique advertisement may have different values assigned to data fields in its representative advertisement record such that an advertisement record can identify a particular advertisement.

Advertisement maps that are used by the interactive television application in selecting advertisements for display may also be represented by records (“advertisement map records”). Main facility 52 of FIG. 1 (which stores interactive television application data) may transmit these advertisement map records at suitable intervals to update the selection of advertisements suitable for display by the interactive television application. Each advertisement map record may include at least one targeted advertisement slot that can be used to specify targeted advertisements, and their associated targeted criteria.

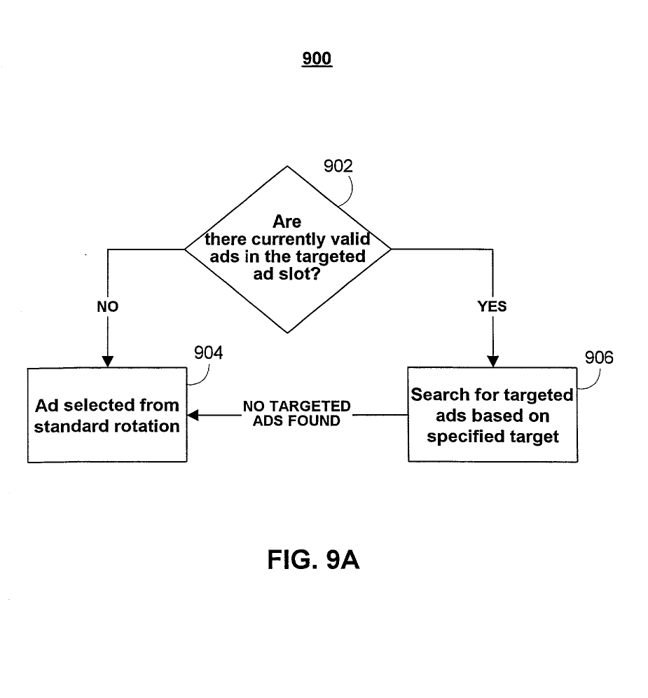

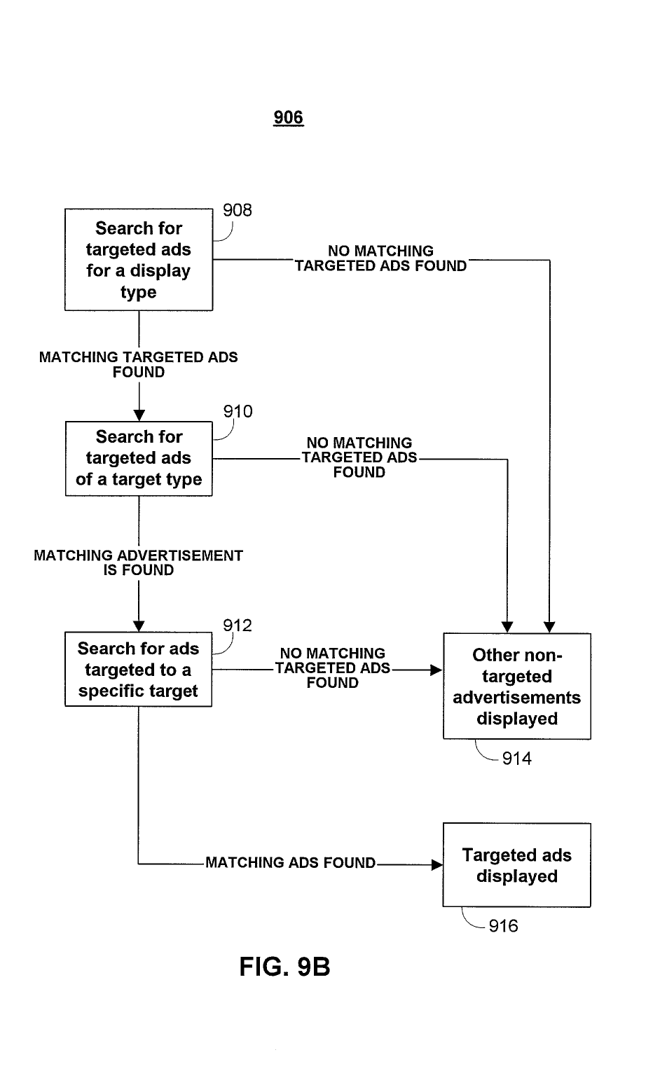

One approach that the interactive television application may use to provide targeted advertisements in conjunction with advertisement map records is illustrated by flow chart 900 of FIG. 9A. At step 902 of FIG. 9A, the interactive television application may check an advertisement map record to see if there are any advertisements specified by the targeted advertisement slot that are currently valid. The targeted advertisement slot of the advertisement map record may include data fields called “start time” and “end time” that indicate the start and end of the time period for which the targeted advertisements specified by the targeted advertisement slot are valid.

At step 904, if the targeted advertisement slot does not specify any targeted advertisements that are currently valid because the current time does not fall between the start time and end time of the targeted advertisement slot, some other advertisement such as a non-targeted advertisement from the standard rotation of the interactive television application may be displayed. At step 906, if the targeted advertisement slot does specify targeted advertisements that are currently valid, the interactive television application may select targeted advertisements to be displayed based on the current channel, network, genre, channel grouping, or other specified target. If no targeted advertisements are specified by the targeted advertisement slot that are targeted to the specified target, advertisements may be selected from the standard rotation for display at step 904.

Step 906 may include various sub-steps that are illustratively shown in FIG. 9B. At step 908, the interactive television application may search for targeted advertisements for a type of display (e.g., flip display, browse display, full-screen display, etc.). If there are targeted advertisements for the type of display that the interactive television application is searching for, the interactive television application may look for advertisements targeted to a specific target type or types (e.g., channel, network, channel grouping, genre, etc.) at step 910.

If there are targeted advertisements that correspond to the specific target type or types that the interactive television application is looking for, the interactive television application searches among these targeted advertisements for advertisements that correspond to a specific target (i.e., the current channel, network, genre, channel grouping, etc.) at step 912. If targeted advertisements that match the specific target are found, they may be displayed by the interactive television application at step 916.

Steps 908, 910, and 912 may be combined in any suitable combination. For example, the interactive television application may determine whether a targeted advertisement is of a matching target type and is targeted to the specified target simultaneously (steps 910 and 912). At any of steps 908, 910, or 912, if the interactive television application does not find a matching advertisement, the interactive television application may select non-targeted advertisements to be displayed at step 914. At step 912, if multiple suitable targeted advertisements are found by the interactive television application, the interactive television application may rotate between displaying any of these suitable targeted advertisements.

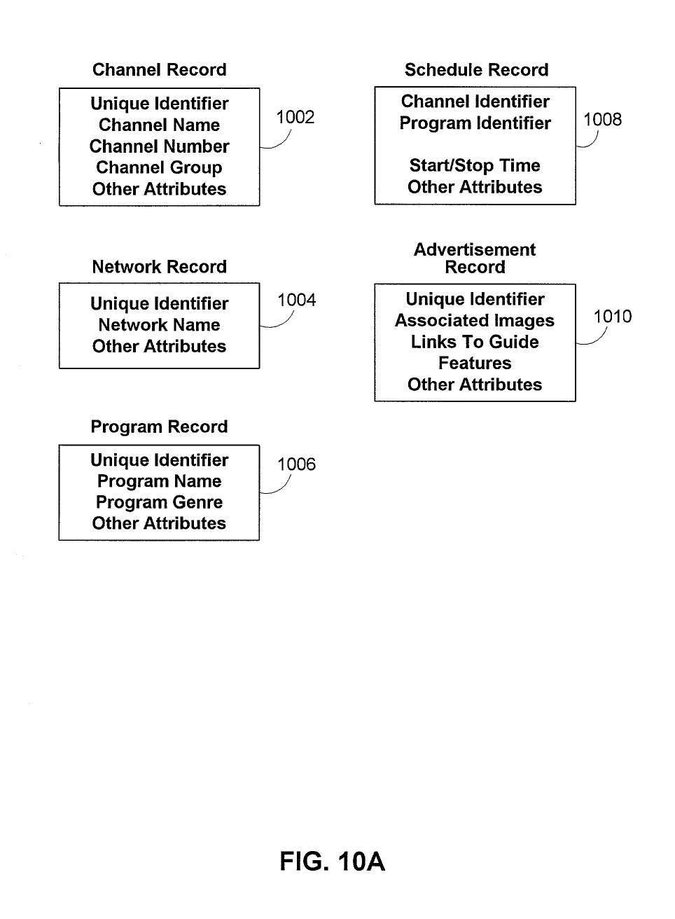

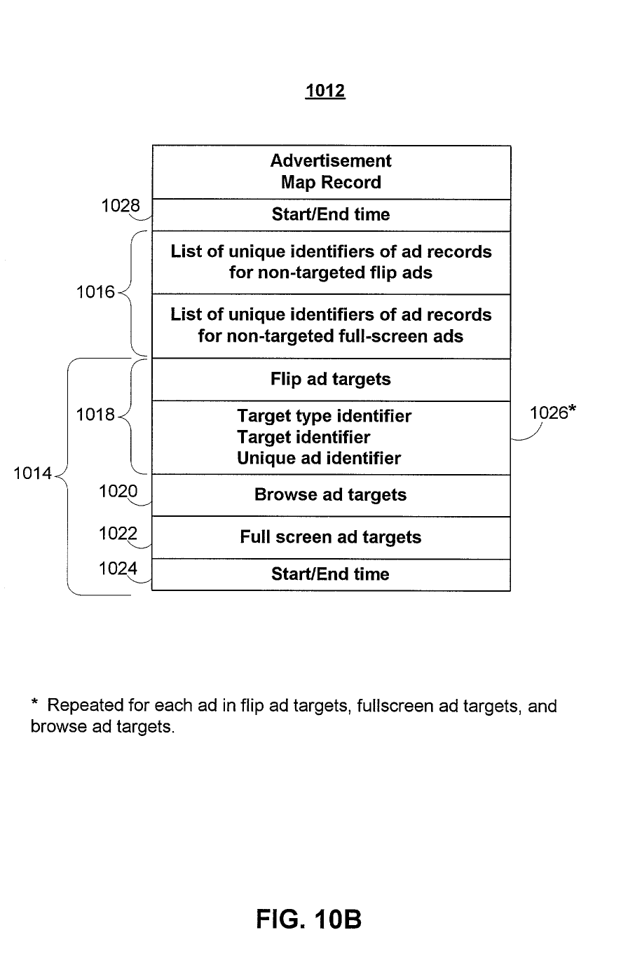

Other than the advertisement records and advertisement map records described above, other types of records that may be used by the interactive television application are illustrated in FIG. 10A. Illustrative records shown in FIG. 10A include channel record 1002, network record 1004, program record 1006, schedule record 1008, and advertisement record 1010. Each channel may be associated with a unique instance of channel record 1002 that includes attributes such as a unique identifier, a channel name, a channel number, or a channel group. Each attribute may be represented by a data field. Each network may be associated with a unique instance of network record 1004 that includes attributes such as a unique identifier or a network name, wherein each attribute may be represented by a data field. Each program may be associated with a unique instance of program record 1006 that includes attributes such as a unique identifier, a program name, or a program genre. Each program attribute may be represented by a data field. Each schedule (i.e., for a particular period of time) may be associated with a unique instance of schedule record 1008 that includes attributes such as a unique identifier that may be represented by a data field. Each advertisement may be associated with an instance of advertisement record 1010 that may include attributes such as a unique identifier, associated images, or links to the guide features that may each be represented by a data field.

As illustrated in FIG. 10B, and previously discussed in relation to FIGS. 9A and 9B, advertisement map record 1012 may include a targeted advertisement slot 1014 and lists of non-targeted advertisements 1016. Targeted advertisement slot 1014 may include start/end time 1024 that indicates whether slot 1014 covers the current time. Targeted advertisement slot 1014 may include sections for each type of display, e.g., flip display section 1018, browse display section 1020, full screen display section 1022, etc. Each of sections 1018, 1020, 1022 includes all information related to providing targeted advertisements for that type of display.

When the interactive television application is determining which targeted advertisement to display, it searches through one of sections 1018, 1020, and 1022. Item 1026 is a typical entry in each of these sections, and is repeated for each targeted advertisement that is provided for each of sections 1018, 1020, 1022.

When the interactive television application searches through a particular section for a targeted advertisement for display, it may start at the beginning of the section (or any other suitable point), and then search through the section until a suitable targeted advertisement is found for display.

As shown in FIG. 10B with illustrative item 1026, each entry may contain attributes such as a target type identifier (which identifies whether the targeted advertisement is targeted to channel, network, channel group, or any other suitable targeting criteria), target identifier (which identifies the specific channel, network, channel group, etc.), and a unique identifier (corresponding to that found in advertisement record 1010). The interactive television applications may use all of these attributes to determine if a particular entry (and thus, targeted advertisement) is to be displayed. For example, if target type identifier of an entry is “program”, the interactive television application will compare target identifier with the program identifier of the current program (corresponding to that found in program record 1006 for the current program). If the target identifier and the current program's unique identifier are the same, there is a match. If not, the interactive television application looks at the next entry in the section. Implicitly, each targeted advertisement in a specific section of advertisements may be prioritized for display based on the targeted advertisement's order in the section.

If the target type identifier of an entry is “channel”, the interactive television application compares the target identifier of that entry with the unique identifier of the currently tuned channel. If the target type identifier of an entry is “network”, the interactive television application compares the target identifier of that entry with the unique identifier of the currently tuned network. If the target type identifier of an entry is “channel grouping”, the interactive television application compares the target identifier of that entry with the unique identifier of the currently tuned channel grouping. If no matching entries are found in the entire section, the interactive television application may display a non-targeted advertisement.

Entries in a particular section in advertisement map record 1012 may also be sorted by target type, such that targeted advertisements of a particular target type may be of higher priority. For example, advertisements targeted to programs may be of higher priority than advertisements targeted to a channel group, or vice-versa. An advertisement may be listed multiple times in a section, if it is targeted based on more than one target type, e.g., when an advertisement is targeted based on “network” and “program”.

When the interactive television application has found an entry in a section of targeted advertisement slot 1014 that matches its searching criteria, the targeted advertisement corresponding to that entry may be displayed as long as the searching criteria do not change. Alternatively, the interactive application may find multiple advertisements that match its searching criteria, and display each advertisement in rotation as long as each advertisement matches its searching criteria.

The foregoing is merely illustrative of the principles of this invention and various modifications may be made by those skilled in the art without departing from the scope and spirit of the invention.

What is claimed is:

1. An apparatus comprising user equipment on which an interactive television application is implemented to configure the user equipment to:
display media on the user equipment;
target an advertisement to the current media by identifying an advertisement that is related to a current media that is being displayed; and
display the advertisement in an interactive television application display when the current media is displayed.

2. The apparatus of claim 1 wherein the current media is a program and the user equipment is configured to identify the advertisement for display based on that program.

3. The apparatus of claim 1 wherein the user equipment is configured to identify the advertisement for display based on the channel for that media.

4. The apparatus of claim 1 wherein the user equipment is configured to identify the advertisement for display based on the network for that media.

5. The apparatus of claim 1 wherein attributes are associated with the current media and the user equipment is configured to identify the advertisement for display based on the attributes.

6. The apparatus of claim 1 wherein the user equipment configured to identify an advertisement that is related to a current media that is being displayed comprises user equipment configured to identify the advertisement from among a group of advertisements associated with the current media.

7. The apparatus of claim 1 wherein the interactive television application display is a flip overlay.

8. The apparatus of claim 1 wherein the interactive television application display is a browse overlay.

9. The apparatus of claim 1 wherein the interactive television application display is a substantially full-screen display screen.

10. The apparatus of claim 1 wherein the interactive television application display is a picture-in-guide display screen.

11. The apparatus of claim 1 wherein the interactive television application display is a display screen invoked when the user accesses a particular interactive television application feature.

12. The apparatus of claim 1 wherein the user equipment is configured to automatically display the interactive television application display.

13. The apparatus of claim 1 wherein the user equipment is configured to display the interactive television application display in response to a user selection.

14. The apparatus of claim 1 wherein the user equipment comprises a set-top box.

15. The apparatus of claim 1 wherein the user equipment is configured to identify the advertisement from a group of advertisements based on a link that exists between the group of advertisements and the current media.

16. A system for using an interactive television application to provide targeted advertisements comprising:
means for displaying media on user equipment;
means for targeting an advertisement to the current media by identifying an advertisement that is related to a current media that is being displayed; and
means for displaying the advertisement in an interactive television application display when the current media is displayed.

17. The system of claim 16 wherein the current media is a program and the means for targeting comprises means for identifying the advertisement for display based on that program.

18. The system of claim 16 wherein the means for targeting comprises means for identifying the advertisement based on the channel for the media.

19. The system of claim 16 wherein the means for targeting comprises means for identifying the advertisement based on the network for that media.

20. The system of claim 16 wherein the means for targeting comprises means for associating attributes with the current media and identifying the advertisement for display based on those attributes.

21. The system of claim 16 wherein the means for targeting comprises means for identifying the advertisement from among a group of advertisements associated with the current media.

22. The system of claim 16 wherein the interactive television application display is a flip overlay.

23. The system of claim 16 wherein the interactive television application display is a browse overlay.

24. The system of claim 16 wherein the interactive television application display is a substantially full-screen display screen.

25. The system of claim 16 wherein the interactive television application display is a picture-in-guide display screen.

26. The system of claim 16 wherein the interactive television application display is a display screen invoked when the user accesses a particular interactive television application feature.

27. The system of claim 16 wherein the means for displaying the advertisement in the interactive television application display comprises means for automatically displaying the interactive television application display.

28. The system of claim 16 the means for displaying the advertisement in the interactive television application display comprises means for displaying the interactive television application display in response to a user selection.

29. The system of claim 16 wherein the user equipment comprises a set-top box.

30. The system of claim 16 wherein the means for identifying the advertisement comprises means for identifying the advertisement from among a group of advertisements is based on a link that exists between the group of advertisements and the current media.

31. A method for targeting advertisements comprising:
displaying media on user equipment;
targeting an advertisement to the current media by identifying an advertisement that is related to a current media that is being displayed; and
displaying the advertisement in an interactive television application display when the current media is displayed.

32. The method of claim 31 wherein the current media is a program and the identifying is based on that program.

33. The method of claim 31 wherein the targeting comprises identifying the advertisement based on the channel for the media.

34. The method of claim 31 wherein the targeting comprises identifying the advertisement based on the network for that media.

35. The method of claim 31 wherein the targeting comprises associating attributes with the current media and identifying the advertisement for display based on those attributes.

36. The method of claim 31 wherein the targeting comprises identifying the advertisement from among a group of advertisements associated with the current media.

37. The method of claim 31 wherein the interactive television application display is a flip overlay.

38. The method of claim 31 wherein the interactive television application display is a browse overlay.

39. The method of claim 31 wherein the interactive television application display is a substantially full-screen display screen.

40. The method of claim 31 wherein the interactive television application display is a picture-in-guide display screen.

41. The method of claim 31 wherein the interactive television application display is a display screen invoked when the user accesses a particular interactive television application feature.

42. The method of claim 31 wherein the displaying comprises means for automatically displaying the interactive television application display.

43. The method of claim 31 wherein the displaying comprises displaying the interactive television application display in response to a user selection.

44. The method of claim 31 wherein the user equipment comprises a set-top box.

45. The method of claim 31 wherein the targeting comprises identifying the advertisement from among a group of advertisements based on a link that exists between the group of advertisements and the current media.
